(19) United States
(12) Patent Application Publication
(10) Pub. No.: US 2016/0284164 A1
(43) Pub. Date: Sep. 29, 2016

(54) SYSTEMS AND RELATED TECHNIQUES FOR TIME-BASED GAMBLING VIA NETWORK-CONNECTED CLIENT DEVICES

(71) Applicant: EVENTERTAINMENT, LLC, Las Vegas, NV (US)

(72) Inventor: James ADAMS, Las Vegas, NV (US)

(21) Appl. No.: 14/667,611

(22) Filed: Mar. 24, 2015

(51) Int. Cl. G07F 17/32

(52) U.S. Cl. CPC G07F 17/3244

(57) ABSTRACT

In one embodiment of the disclosed techniques, a system includes a processor and a memory with a game play module and a random probability calculation module. The game play module is configured to identify a subset of client devices from a plurality of client devices configured to access an online gaming system, where each client device in the subset is actively accessing the online gaming system during a first time period. The game play module is further configured to allocate a portion of subscription fees collected from the client devices to a winnings pool. The random probability calculation module is configured to determine that a jackpot is to be awarded at a point in time within the first time period from the winnings pool. The random probability calculation module is further configured to select a client device from the identified subset of client devices to receive the jackpot.

### BACKGROUND OF THE INVENTION

1. Field of the Invention

Embodiments of the present invention relate generally to distributed systems for online gaming and, more specifically, to systems and related techniques for time-based gambling via network-connected client devices.

2. Description of the Related Art

In traditional gambling and games of chance, players place specific bets at the beginning of a particular hand or round, and sometime place additional specific bets at other times during the game. In one example, players could place various bets prior to each spin of a roulette wheel. In another example, players could place bets at the beginning of a hand of blackjack. Players could also place additional bets at various points in the game, as when buying insurance against the dealer when the house is showing an ace card or when splitting a pair of identically-ranked cards. In yet another example, players could ante a particular amount of money at the beginning of a hand of poker and could increase their bets as new cards are played during the hand. In yet another example, players could play a single coin or token in a slot machine, and, prior to pulling the handle or pressing the play button, could optionally play additional coins or tokens to increase the quantity of simultaneous plays, to increase the quantity of ways by which to achieve a winning combination, or to increase the value of a multiplier if a winning combination comes up.

Certain games are designed to pool money that is potentially shared among a group of players, rather than having each player bet solely against the house. One example of this type of game is a group of networked slot machines with pooled jackpots that increases with each play of a participating slot machine and decreases with each payout of a pooled jackpot. Another example of this type of game is an online poker, blackjack, or other game where participants' bets are pooled, and a percentage of the pooled bets is paid out in winnings

One characteristic with all of these games is that players place per-game bets, which leads to various drawbacks. One potential drawback is that, because players are conscious of each time they place bets, players may choose to limit play at some point if they feel they have gambled too much money. This drawback results from the fact that each bet requires a discrete wagered about, representing a fixed amount for each separate play. As a result, players often choose to stop gambling after participating in a certain quantity of games, rounds, or hands of play. Another potential drawback is that the amount of money available for payout of winnings can vary significantly from one game, round, or hand to the next. As a result, the amount that the house can afford to pay on a particular game, round, or hand may vary widely, and players may be frustrated when a particular winnings payout is low, even though a previous recent payout was relatively high. Consciousness of betting amounts and high variability of winnings payouts can lead to reduced player participation over time.

In addition, a wide variety of online games are available for playing on various personal computing devices, such as desktop computers, laptop computers, computing tablet devices, smartphones, and other mobile game devices. Typically, such online games may be downloaded and played for no fee or for a modest fee. To generate revenue, players are offered additional tokens for play or various virtual items associated with playing the game for additional fees. After initial enthusiasm for playing the game and buying additional tokens and virtual items, players often fatigue of the game and reduce or eliminate the amount of time spent playing the game. As a result, providers of such online games are desirous of additional revenue streams beyond selling game tokens and various virtual items.

As the foregoing illustrates, what is needed in the art is a more effective technique for pooling bets for online players and paying out associated winnings

### SUMMARY OF THE INVENTION

One embodiment of the present invention sets forth a system that includes a processor and a memory that includes a game play module and a first random probability calculation module. The game play module, when executed by the processor, is configured to identify a first subset of client devices from a plurality of client devices configured to access an online gaming system, wherein each client device included in the first subset of client devices is actively accessing the online gaming system at a first point in time within a predetermined time period. The game play module, when executed by the processor, is further configured to allocate a first portion of subscription fees collected from the plurality of client devices to a first winnings pool. The first random probability calculation module is associated with a first winnings pool module and, when executed by the processor, is configured to determine that a first jackpot is to be awarded at the first point in time within the predetermined time period from the first winnings pool. The first random probability calculation module, when executed by the processor, is further configured to select a first client device from the first subset of client devices identified by the game play module to receive the first jackpot.

In some embodiments, the payout may be triggered based on time periods. In one example, a payout could be made to six participants per second, where the six participants for a particular second would be selected at random. In another example, payout could be based on a dual-step approach, where, in a first step, the timing of a payout would be determined as a random probability function, and, in a second step, for a particular time period that has been selected for a payout, the winning participant is selected at random from the current set of participants during the selected time period.

Other embodiments include, without limitation, a computer-readable storage medium that includes instructions that enable a processing unit to implement one or more aspects of the disclosed approaches as well as a computer-implemented method for performing one or more aspects of the disclosed approaches.

At least one advantage of the disclosed techniques is that large predictable winnings payouts are paid to players of online gaming systems, leading to predictable payouts and excitement among players. Another advantage of the disclosed techniques is that, because of the absence of per-game bets and the increase of winnings opportunities as game play time increases, the average amount of time spent playing increases relative to prior approach. These advantages lead to increased user participation. Yet another advantage of the disclosed techniques is that because a fixed wager amount is paid for a variable quantity of wagers, the discrete amount per wager effectively reduces over time, as a player increases the time of play during the subscription period. In other words, the player can play for the entire subscription period without committing additional funds for further wagers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating an exemplary distributed computing system configured to implement one or more aspects of the present invention;

FIG. 2 is a block diagram illustrating a computing system configured to implement one or more aspects of the present invention; and

FIG. 3 sets forth a flow diagram of method steps for electronically paying out winnings for a particular probability calculation period, according to another embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

A computer-based online gaming system communicates with one or more client devices, where each client device is associated with a particular player of the online gaming system. The online gaming system receives a request from a client device to establish a new account for the associated player. In response, the online gaming system creates an account for the client device and electronically transfers an amount of money from an account associated with the client device to an account associated with the online gaming system. This amount of money serves as a subscription fee that provides unlimited access by the client device to the online gaming system for a predetermined time period associated with the time stamp. Typically, the predetermined period of time is a quantity of hours, days, weeks, or months. These subscriptions fees are collected for an arbitrary quantity of players/client devices, potentially hundreds or thousands of client devices.

The online gaming system allocates a portion of the total collected subscription fees to an account associated with a provider or sponsor of the online gaming service. This allocation covers the costs and profits associated with providing the online gaming service. The online gaming service then allocates a portion of the remaining subscription fees to one or more winnings pools.

The online gaming system continuously monitors the set of client devices logged into the online gaming system to identify the subset of logged in client devices that are actively communicating with a computer game associated with the online gaming system. At periodic intervals, such as one second, the online gaming service performs a random probability calculation for each of the winnings pools to determine whether a jackpot is awarded for a given interval for the corresponding winnings pool. If so, the online gaming service selects a client device at random from the subset of client devices actively accessing the online gaming system during the corresponding interval. The client device transfers the jackpot winnings to an account associated with the selected client device. The process repeats for each successive periodic interval. Via the disclosed online gaming system, large, predictable pools of money are generated in this way and paid to player solely on the basis of who is online, leading to increased participation of all players at all skill levels.

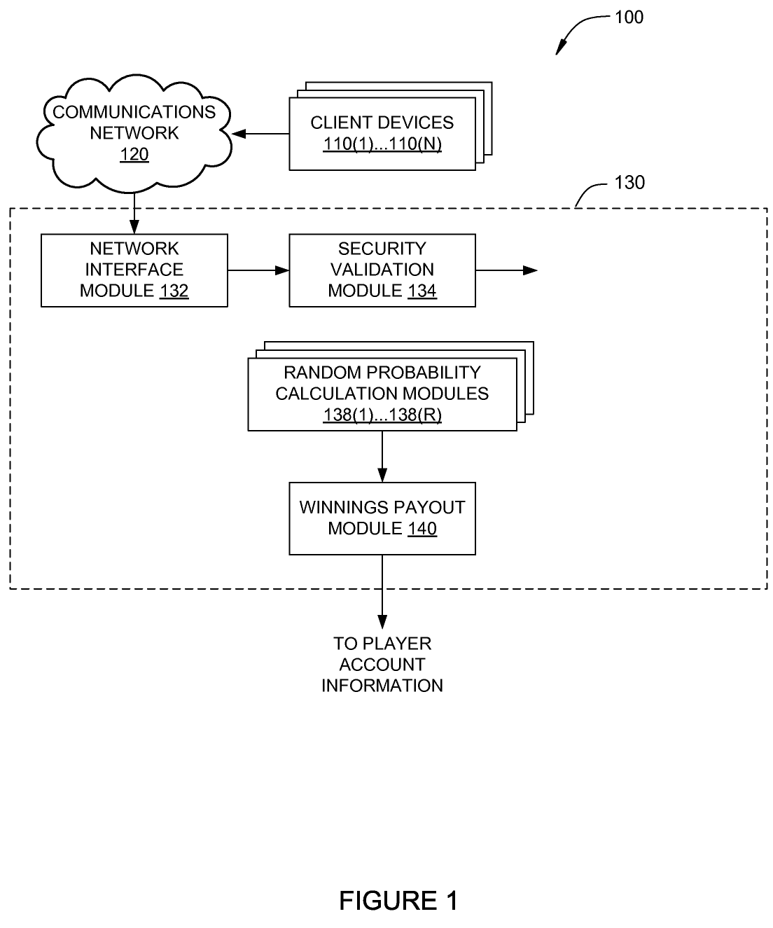

FIG. 1 is a block diagram illustrating an exemplary distributed computing system 100 configured to implement one or more aspects of the present invention. As shown, the distributed computing system 100 includes client devices 110(1) . . . 110(N), a communications network 120, and an online gaming system 130.

In operation, the client devices 110(1) . . . 110(N) communicate with the online gaming system 130 over the communications network 120. Each of the client devices 110(1) . . . 110(N) subscribes, for a subscription fee, to a particular period of game play on the online gaming system 130. Each client device 110 is associated with a particular player of one or more games associated with the online gaming system 130. The client devices 110(1) . . . 110(N) include any technically feasible computing device with a network interface, including, without limitation, desktop computers, laptop computers, computing tablet devices, smartphones, and other mobile game devices, in any combination.

The players participate in a network of game players who all agree to purchase the right to play one or more online video games hosted on the online gaming system 130. These players pay a subscription fee for the right to play these games (whether that fee is for long period of time, such as a month, or for a shorter period of time, such as a designated number of hours). This technique is referred to herein as time-based play. As described in greater detail below, this subscription fee provides each player a multitude of opportunities to win a jackpot funded by the pool of subscription fees for so long as the client device 110 associated with a given player is actively accessing the online gaming system 130.

In order to have the opportunity to win a jackpot, the player does not make a traditional wagering decision or submit a specified amount of money as part of a discrete wagering transaction (such as pushing a slot machine button or participating in a hand of poker). Rather, the player engages in one or more computer-based games, where each computer-based game is task oriented, skill oriented, or has any technically feasible structure that enables the player to proceed through the game. Typically, the player plays the game because the game is fun and enjoyable, rather than specifically for the main purpose of winning a jackpot. Regardless of the player's skill, or aptitude at the game, the player's chance to win a jackpot is exactly the same. In other words, the player has the opportunity to win a jackpot regardless of how successful the player is at completing the game. As further described herein, the opportunity for the player to win a jackpot is solely based on whether the player, via an associated client device, is actively accessing the online gaming system 130 to play the game.

Stated another way, when a player pushes a button to move a character, make a decision, or complete a task in a computer-based game, the action by the player has no positive or negative impact on the likelihood of winning a jackpot via the online gaming system 130. That is, a player does not explicitly or implicitly submit a discrete wager during game play nor does the skill of a player in the game impact the odds of winning a particular jackpot.

Via the client devices 110(1) . . . 110(N), the players engage in a new kind of wagering—where initial subscription fees levied on the players serve to fund one or more jackpot winnings pools, as described herein, and to provide revenue to the provider of the online gaming system. These subscription fees are typically non-refundable, and are paid in exchange to participate in the network and play the associated computer-based game or games for a specified duration of time. While a group of players participate in the games, the online gaming system 130 continually performs random probability calculations and awards jackpots at periodic intervals based on these calculations. That is, in exchange for a single subscription fee payment, players place multiple wagers over an extended period of time without having to spend more than the initial subscription fee. Stated another way, a player does not select a specific amount of funds to wager on a discrete transaction, as with prior art approaches, and a wager is not submitted as a result of the player taking a specific action. Rather, the wager occurs automatically each time a probability calculation is completed during the period of time that the player is logged onto the online gaming system 130 and is actively participating in game play.

Because the subscription fee is paid once for a given duration, as the player increases the time spent playing during the subscription fee period, the quantity of wagers increases, and, correspondingly, the amount spent per wager decreases.

In one example, a player could pay a subscription fee of $30 for each month of game play. If a player participated in only one probability calculation, then the effective amount of the wager would be $30. If, on the other hand, a player remains on-line playing the game for 1,000 probability calculations, the effective amount of each wager would be $0.003.

The communications network 120 facilitates communications between the client devices 110(1) . . . 110(N) and the online gaming system 130. In various embodiments, the communications network 120 may include any wired or wireless technique for facilitating communications among devices that are not directly connected.

The online gaming system 130 is a computing platform for executing the techniques described herein. In various embodiments, the online gaming system 130 may be implemented on a single computing system or, alternatively, may be implemented on various computing systems and other components that communicate with each other over a network, such as communications network 120. Typically, the online gaming system 130 is implemented via one or more server devices that compute probability functions and award portions of corresponding winnings pools to accounts associated with the various client devices 110(1) . . . 110(N). Such accounts include, without limitations, bank accounts, credit card accounts, e-wallet accounts, and online payment accounts. As shown, and without limitation, the online gaming system 130 includes a network interface module 132, a security validation module 134, a game play module 136, random probability calculation modules 138(1) . . . 138(R), and a winnings payout module 140. In various embodiments, two or more of the modules listed above may be consolidated, within the scope of this disclosure. Further, in various embodiments, one or more of the modules listed above may be eliminated, within the scope of this disclosure.

The network interface module 132 receives messages from one or more client devices 110(1) . . . 110(N) via the communications network 120. The network interface module passes these received messages to the security validation module 134. The network interface module 132 receives, via the security validation module 134, messages from the various other modules of the online gaming system 130, and forwards the messages to one or more client devices one or more client devices 110(1) . . . 110(N), as appropriate.

The security validation module 134 performs various functions to validate a player's credentials via the player's client device 110. If the security validation module 134 receives a request to open a new account, the security validation module 134 validates the identity and age of the player via information entered by the player into the client device 110. The security validation module 134 also validates an account associate with the client device 110 that includes funds from which to extract subscription fees and to which to deposit winnings In some embodiments, the security validation module 134 receives selections from the client device 110 as to the duration of play and as to whether or not the subscription is to be automatically renewed, and an additional subscription fee is to be extracted from the account, each time the current duration of play expires. Once the validation steps are completed, the security validation module 134 allows the client device 110 to access the online gaming system 130.

On future accesses by the client device 110, the security validation module 134 determines if the duration of play for the most recent subscription is still active. If so, then the security validation module 134 allows the client device 110 to access the online gaming system 130. If not, then the security validation module 134 denies access to the online gaming system 130. In some embodiments, if the most recent subscription has expired, then the security validation module 134 automatically renews the subscription for the client device 110, extracts an appropriate subscription fee from an account associated with the client device 110, and allows the client device 110 to access the online gaming system 130.

The game play module 136 assigns subscription fees to various winnings pools and to an administrative account. In one example, the game play module 136 could assigns 10% of the subscription fees to an administrative account to provide funds to cover operating costs and profit for the provider of the online gaming system 130. The game play module would then divide the remaining 90% of subscription fees to winnings pools, where each winnings pool is associated with a different random probability calculation module 138. If there are three winnings pools, then the game play module 136 could assign 30% of the subscription fees to each of the three pools. Alternatively, the game play module 136 could assign 10% of the subscription fees to a first pool, 30% to a second pool, and 50% to a third pool.

In addition, the game play module 136 periodically tracks which eligible players are logged in via corresponding client devices 110(1) . . . 110(N) and are actively participating in at least one of the network-based games associated with the online gaming system 130. The game play module 136 determines the set of client devices 110(1) . . . 110(N) that are actively participating in at least one of the network-based games via any technically feasible approach. In one example, the game play module 136 could determine the set of actively participating client devices 110(1) . . . 110(N) based solely on which client devices 110(1) . . . 110(N) are currently logged into the online gaming system 130. In another embodiment, the game play module 136 could determine the set of actively participating client devices 110(1) . . . 110(N) based on receiving a message from a given client device 110 within a previous recent duration, such as within the last five seconds. In yet another embodiment, the game play module 136 could determine the set of actively participating client devices 110(1) . . . 110(N) based the set of client devices 110 that transmit a “ping” message to the game play module 136 in response to another ping message sent by the game play module 136 to all client devices 110(1) . . . 110(N).

The game play module 136 also generates a list of actively participating players for each period that might result in awarding one or more winnings payouts. For example, if a winnings payout could be paid for each second of play, the game play module 136 generates a list of actively participating players once per second. As a result, a player has a varying number of chances to win a jackpot, based on how much time the player spends actively participating in a game via his or her client device 110. For example, if a player purchases a one-month subscription (presuming a 30 day calendar month), then that player would have a maximum of 30×24×60×60=2,592,000 changes to win a jackpot. If the player actively participates for two hours each day during the subscription period, then that player would be listed on 30×2×60×60=216,000 actively participating players lists, as generated by the game play module 136, and would have 216,000 chances to win a jackpot.

In some embodiments, the game play module 136 includes a software application that executes the game played by one or more actively participating players. In other embodiments, an application residing on the client devices 110 executes the game played by the player associated with the client devices 110. In yet other embodiments, the online gaming system 130 facilitates play for multiple games, where the game play module 136 includes one or more software application that executes one or more games of the multiple games, while one or more applications residing on the client devices 110 execute other games of the multiple games.

Because winnings payouts are awarded to actively participating players, and not on the skill set of individual players, players are incentivized to play as often as possible during the subscription period, so as to be listed on as many actively participating players lists as possible. That is, players are incentivized to stay logged in and play a game because it is fun and because as long as they continue to play, they receive additional opportunities to win a jackpot, independent of their performance in the game and regardless of whether they have won any prior jackpots. Upon generating the actively participating players lists, the game play module 136 transmits each generated list to the random probability calculation modules 138(1) . . . 138(R).

The random probability calculation modules 138(1) . . . 138(R) periodically calculate a probability function to determine whether there is to be a payout from a corresponding winnings pool for each period, and, if there is to be a payout for a particular period, select the player that wins the payout from the set of players actively playing during the period. In one embodiment, if there is to be a payout, the random probability calculation modules 138(1) . . . 138(R) select one or more players at random from the set of players actively playing during the period. When a player wins a payout, all or a designated portion of the jackpot associated with the specific calculation is paid to the client device 110 associated with the winning player. The player is notified that he or she has won a designated amount of funds, and such funds are deposited in an account and are available for withdrawal by the player.

Each of the random probability calculation modules 138(1) . . . 138(R) are configured to pay all or a portion of the amount allocated to the corresponding winnings pools during each subscription fee duration. For example, a random probability calculation module 138 could be configured to pay out all of the funds in the corresponding winnings pool for each subscription fee duration. Alternatively, a random probability calculation module 138 could be configured to pay out a specified amount, such as $1,000,000 or a particular percentage, such as 90%, from the corresponding winnings pool. Each winnings payout could be the same amount, based on the total amount in the winnings pool and on the quantity of payouts to be made during a given duration. Alternatively, the amount of each winnings payout could vary, by randomly selecting a dollar amount from a range, such as $5-$30, or by randomly selecting a percentage, such as 1%-10% of the winnings pool.

In one example, the online gaming system 130 could include three random probability calculation modules 138 corresponding to three winnings pools, where a first winnings pool is associated with a probability calculation that is designed to pay out small portions of the winnings pool on a frequent basis, a second winnings pool is associated with a probability calculation that is designed to pay out medium-sized portions of the winnings pool on a intermediate frequency, and a third winnings pool is associated with a probability calculation that is designed to pay out the entire amount of the winnings pool on a relatively infrequent basis. If there are 60 million players who each pay $30 per month, then a total of $1.8 billion in monthly subscription fees is generated. If 10% of the fees is assigned to the administrative account, then the remaining 90% could be divided among three winnings pools as follows:
Total Subscription Fees: $1,800,000,000
Gaming Operator Revenue (10%): $180,000,000
Short Term Jackpot Pool (30%): $540,000,000
Medium Term Jackpot Pool (10%): $180,000,000
Long Term Jackpot Pool (50%): $900,000,000
Total amount returned to game players: $1,620,000,000

The first random probability calculation module 138, corresponding to the short term winnings pool, could be associated with a winnings pool funded with 30% of the subscription fees ($540 million). The first random probability calculation module 138 could be configured to pay out $8 per winnings payout and to pay out the entire winnings pool during the subscription duration. As a result, the first random probability calculation module 138 would pay out 67,500,000 winnings payouts per month. If probability calculations are performed once per second, the first random probability calculation module 138 would be configured to pay out, on average, 67,500,000/2,592,000=approximately 26 jackpots per second. Because the winnings payouts are randomly selected, a given period could have a larger or smaller number of jackpot payouts than 26.

For each calculation period, the first random probability calculation module 138 would assign a unique identifier to each player actively participating in an online game and then would randomly select 26 identifiers from the total set of all identifies for each discrete calculation. Those 26 identifiers would then be matched to the corresponding accounts assigned to the winning players' client devices 110 to identify the winning players and generate a payout to each player the designated portion of the jackpot pool, such as $8. The first random probability calculation module 138 would then repeat the calculations for each set interval, such as once per second. All players currently playing the game would be eligible to win, regardless of whether a player has won during a preceding probability calculation.

The second random probability calculation module 138, corresponding to the medium term winnings pool, could be associated with a winnings pool funded with 10% of the subscription fees ($180 million). The second random probability calculation module 138 could be configured to pay out $1 million per winnings payout and to pay out the entire winnings pool during the subscription duration. As a result, the second random probability calculation module 138 would pay out 180 winnings payouts per month. If probability calculations are performed once per second, the second random probability calculation module 138 would be configured to pay out, on average, 180/2,592,000=one jackpot every 14,400 seconds, or one jackpot every four hours. The probability that a given time period is selected for a winnings payout is based on a random probability function. Because the timing of the winnings payouts is randomly selected, a given period between two successive jackpot payouts could be greater than or less than 14,400 seconds. Further, because players could join at any time, a particular payout would not be guaranteed to occur within a particular player's subscription period.

For each calculation period, the second random probability calculation module 138 would assign a unique identifier to each player actively participating in an online game. The second perform a calculation with a probability of 1/14,400 to determine if a payout is to be made for the current period. If a payout is to be made, the second random probability calculation module 138 selects one identifier from the total set of all identifies. That identifier would then be matched to the corresponding account assigned to the winning player's client devices 110 to identify the winning players and generate a payout to each player the designated portion of the jackpot pool, such as $1,000,000. The second random probability calculation module 138 would then repeat the calculations for each set interval, such as once per second. All players currently playing the game would be eligible to win, regardless of whether a player has won during a preceding probability calculation.

The third random probability calculation module 138, corresponding to the long term winnings pool, could be associated with a winnings pool funded with 50% of the subscription fees ($900 million). The third random probability calculation module 138 could be configured to pay out a single winnings payout of the entire winnings pool ($900,000,000) sometime during the subscription duration. As a result, the second random probability calculation module 138 would pay out 1 winning payouts per month. If probability calculations are performed once per second, the third random probability calculation module 138 would be configured to pay out, on average, one jackpot per 2,592,000 seconds, or one jackpot approximately every thirty days. Because the timing of the winnings payouts is randomly selected, a given period between two successive jackpot payouts could be greater than or less than thirty days. Further, because players could join at any time, a particular payout would not be guaranteed to occur within a particular player's subscription period.

For each calculation period, the third random probability calculation module 138 would assign a unique identifier to each player actively participating in an online game. The second perform a calculation with a probability of 1/2,592,400 to determine if a payout is to be made for the current period. If a payout is to be made, the second random probability calculation module 138 selects one identifier from the total set of all identifies. That identifier would then be matched to the corresponding account assigned to the winning player's client devices 110 to identify the winning players and generate a payout to each player the designated portion of the jackpot pool, such as $900,000,000. The third random probability calculation module 138 would then repeat the calculations for each set interval, such as once per second. All players currently playing the game would be eligible to win, regardless of whether a player has won during a preceding probability calculation. In some embodiments, the amount of a payout is limited to not exceed the current balance of funds in the associated winnings pool, such that no winnings pool has a negative balance.

If a player could physically participate actively in online game play for each second of the 30 day month (2,592,000 seconds) in a system with three winnings pools, then that player participates in a total of 3×2,592,000=7,776,000 probability calculations, and has 7,776,000 total chances to win a jackpot. If the player paid a $30 dollar subscription fee, the player would effectively be wagering $30/7,776,000=$0.00000386 per wager and would have the opportunity to potentially win a jackpot as large as $900 million. As described herein, the effective amount of the wager changes depending upon the actual amount of time during the subscription period that the player actually spends actively participating in playing the game (thus determining the actual quantity of probability calculations in which the player participates.

A particular player's chance to win a jackpot during any given probability calculation depends on the odds of the particular probability calculation, as well as the total number of players currently playing the game at the time the calculation is performed. For example, if there are, on average, 2.6 million players at any given moment, the odds of winning a small jackpot would be approximately 1 in 100,000 for any given probability calculation (2.6 million players/26 winners per calculation=1 in 100,000). Presuming a random selection of jackpot winners, an individual wins a small jackpot on average approximately every 28 hours of game play (100,000/3,600 calculations per hour=27.7 hours).

In some embodiments, the random probability calculation modules 138(1) . . . 138(R) may increase the odds of winning certain payouts in order to give players a winning experience and, correspondingly provide additional encouragement for players to continue to participate in online play. For example, a portion of the subscription fees could be allocated to a “knock out” pool. The goal of maintaining a knock out pool could be to increase the odds that each player receives back at least a certain portion of the subscription fees in payouts each period. If the knock out pool is allocated one-third of the subscription fees and the periodic subscription fee is $30, then the goal would be to increase the odds that each player receives back at least one-third of the subscription fees, or $10, in each subscription period. The random probability calculation module 138 for the knock out pool would then, for each period, determine a quantity of knock out payouts to make for that period. That is, the random probability calculation module 138 could make 25 or 50 payouts of $10 to players selected at random from the set of currently active players. Once a player has received a payout from the knock out pool, the player's client device 110 would then be ineligible to receive additional payouts from any winnings pool associated with the knock out pool for the remainder of the current subscription fee. However, the player's client device 110 would still be eligible to receive additional payouts from any winnings pool that is not associated with the knock out pool.

In another example, the random probability calculation modules 138(1) . . . 138(R) could include a random probability calculation module 138 that performs calculations associated with a rebate pool. The goal of maintaining a rebate pool could be to ensure that each player receives back at least a certain portion of the subscription fees in payouts each period. If the rebate pool is allocated one-third of the subscription fees and the periodic subscription fee is $30, then the goal would be ensure that each player receives back at least one-third of the subscription fees, or $10, in each subscription period. The random probability calculation module 138 for the rebate pool would then, for each period, determine a time during the current subscription period when a player receives a payout from the rebate pool. If the player is actively participating in the online gaming system 130 at the determined time, then the client device 110 would receive the rebate payout at the determined time. If the player is not actively participating in the online gaming system 130 at the determined time, then the client device 110 would receive the rebate payout when the player next logs in after the determined time and during the current subscription period. Once a player has received a payout from the rebate pool, the player's client device 110 could still be eligible to receive additional payouts from other winnings pools.

In some embodiments, the payout made to a winning player may be paid to an account that is linked to an online fulfillment service for buying products and services. If a player receives a winnings payout, then the player may choose to purchase products and services via the online fulfillment service, where at least some of the products and services are subject to a special discount available only to players of the online gaming system 130.

In some embodiments, the subscription period for all players is identical. For example, if each subscription fee is for a one-month period starting at the first of the month, then each player would have a subscription period corresponding to a particular month. In such cases, players who join during a particular subscription period may pay a pro-rata amount for the remaining portion of the current subscription period, and then play a full amount for each subsequent subscription period.

In some embodiments, the subscription period for each player would depend on the day of the month that a particular player initiated a login account via a client device 110. In a monthly subscription plan, players who initiate an account on the first of the month would pay a renewal subscription fee on the first of each month in exchange for an additional month of play. Players who initiate an account on the second of the month would pay a renewal subscription fee on the second of each month in exchange for an additional month of play, and so on.

In some embodiments, the online gaming system 130 may be integrated with a “multi-player role-playing game,” where the game may be structured as a virtual world. Each player of the multi-player role-playing game may control a character that is graphically represented in the game by an image of the character. Each player currently playing the game may have a character present in that game, such that all players currently in the game may interact with each other. In other embodiments, a player may manipulate an object in the game to complete certain tasks, such that upon completion of a task, the player may move to the next level of game play. In these other embodiments, the player is not interacting with other players at all, but rather is moving through a level structure that may become progressively more challenging. These embodiments may be described as an “individual game.”

In both multi-player role-playing games and individual games, the game may be designed such that a player receives a benefit in the game as a result of winning a jackpot, in addition to receiving the monetary pay-out of the jackpot. That is, while aptitude and success in the game has no impact on a player's ability to win a jackpot, the result of winning a jackpot may be integrated into the game, such that a player may receive an additional “virtual benefit.” Such virtual benefits may include, without limitation, (i) granting a player access to new levels of game play, including levels not generally accessible by those not participating in the online gaming system 130; (ii) granting a player's character increased skills in the game; (iii) providing a character with virtual items that can be used in the game to accomplish certain tasks or that can be traded to another player; and (iv) conferring virtual status to a player's character such that other players in the game are made aware that the player has won a jackpot, such as by awarding a badge or particular game status to the winning player.

Awarding such virtual benefits may change the gaming experience (e.g., by providing access to new levels or new character skills), thereby making the game more fun to play and encouraging additional participation. Further, virtual benefits may reinforce the experience of winning a jackpot, because it provides the player with an association between a virtual benefit and the corresponding monetary jackpot. The online gaming system 130 may remind the player of the prior win each time the player uses the virtual benefit during game play. Finally, in the case of multi-player role-playing games, other players may be made aware that a player has won a jackpot by seeing that the player has obtained a virtual benefit, and may increase their participation levels in order to increase the odds of also receiving the virtual benefit.

In some embodiments, the online gaming system 130 may be integrated with one or more social networks, where a social network is a website or other online network-based system where individuals may connect and share in common activities. Examples of such social networks may include a website where individuals have an account for posting photos, videos, and hyperlinks to other online content. These photos, videos, and hyperlinks may be viewable by other individuals that the account holder has given permission to view such content. Further, those individuals who have such permission (who may be referred to as the account holder's “friends”) may be permitted to post comments or otherwise indicate their agreement or support for the accountholder's content or postings.

Some social networks provide online games that may be played through the social network via players' smart phones, video game consoles, or other devices, and, in some cases, may be the primary purpose of a particular social network. These online games may be competitively played with other account holders within the social network, where players may communicate directly with each other, share achievements in rankings or status changes among the community of account holders, and otherwise communicate with each other through online techniques. By integrating the online gaming system 130 with such a social network, increased player participation may be encourages as players become aware of winnings payouts made to various players of an online game played by account holders while such account holders are logged into their social network accounts.

Such users may be offered the opportunity to pay a subscription fee to have the right to play one or more online games, including games that may already be available to players on such social networks. Each of these games may be integrated with the online gaming system 130 such that players who access the online gaming system 130 directly and players who access the online gaming system 130 via a social network may share in the same probability calculations and in the same winnings pools. Such embodiments may potentially increase other sources of revenue to the social network operator, to the extent that the social network operator profits from the amount of time a user spends on the social network.

The winnings payout module 140 receives notification of a payout from one or more of the random probability calculation modules 138(1) . . . 138(R). Upon receiving such a notification, the winnings payout module 140 provides notification to the client device 110 associated with the player selected for the payout. The winnings payout module 140 transfers the payout to the account associated with the client device 110. In some embodiments, the winnings payout module 140 may post a notice to one or more social media services associated with the client device 110 to notify a player's social contacts of the payout. In some embodiments, the winnings payout module 140 may also award points or game tokens and may unlock new game levels to players who win a payout via the client device 110.

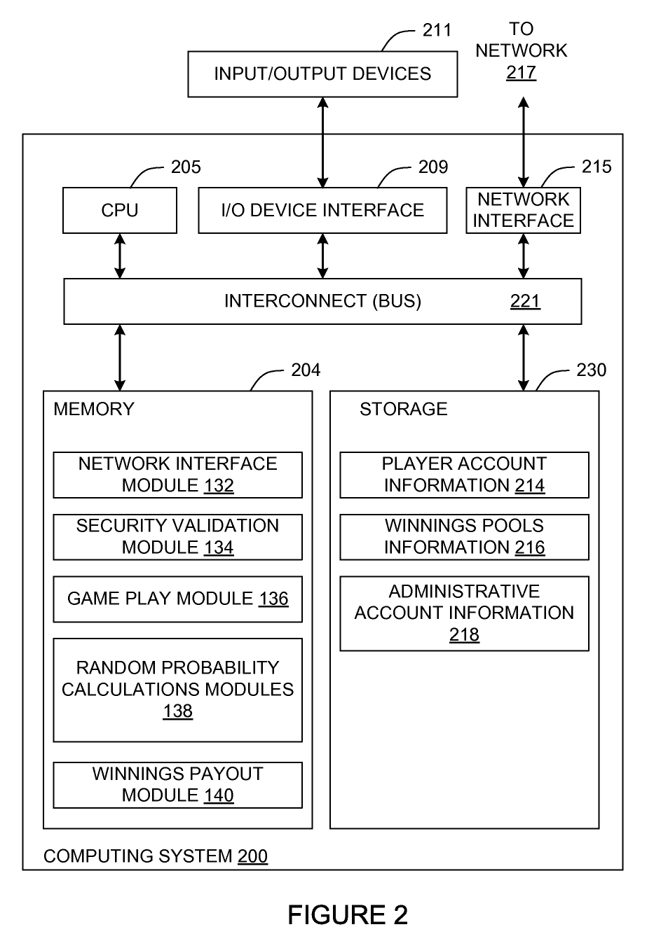

FIG. 2 is a block diagram illustrating a computing system 200 configured to implement one or more aspects of the present invention. In one embodiment, the computing system 200 may be the online gaming system 130 depicted in FIG. 1. The computing system 200 may include at least one of any type of hardware, server, personal computer, mini-computer, mainframe computer, or any computing device either special purpose or general computing device. Further, the modules and applications described herein as being operated on or executed by computing system 200 may be executed entirely on a single device, as shown in FIG. 2, or, alternatively, in other embodiments, separate servers, databases or computer devices may work in concert to provide the various techniques described herein.

As shown, the computing system 200 includes, without limitation, a central processing unit (CPU) 205, a network interface 215 communicatively coupled to a network 217, a memory 204, and storage 230, each connected to a bus 221. The computing system 200 may also include an I/O device interface 209 connecting I/O devices 211 (e.g., keyboard, display and mouse devices) to the computing system 200. Further, in context of this disclosure, the computing elements shown in computing system 200 may correspond to a physical computing system (e.g., a system in a data center) or may be a virtual computing instance executing within a computing cloud.

The CPU 205 retrieves and executes programming instructions stored in the memory 204 as well as stores and retrieves application data residing in the memory 204. The interconnect 221 is used to transmit programming instructions and application data between the CPU 205, I/O devices interface 209, storage 230, network interface 215, and memory 204. Note, CPU 205 is included to be representative of a single CPU, multiple CPUs, a single CPU having multiple processing cores, and the like. And the memory 204 is generally included to be representative of a random access memory. The storage 230 may be a disk drive storage device. Although shown as a single unit, the storage 230 may be a combination of fixed and/or removable storage devices, such as fixed disc drives, removable memory cards, optical storage, network attached storage (NAS), or a storage area-network (SAN).

The computing system 200 includes memory 204, which may comprise volatile and nonvolatile memory such as read-only and/or random-access memory (ROM and RAM), EPROM, EEPROM, flash cards, or any memory common to computer platforms. Further, memory 204 may include one or more flash memory cells, or may be any secondary or tertiary storage device, such as magnetic media, optical media, tape, or soft or hard disk.

Illustratively, the memory 204 includes a network interface module 132, a security validation module 134, a game play module 136, random probability calculation modules 138(1) . . . 138(R), and a winnings payout module 140. As further described herein the network interface module 132 receives messages from one or more client devices 110(1) . . . 110(N) via the communications network 120. The security validation module 134 performs various functions to validate a player's credentials via the player's client device 110. The game play module 136 assigns subscription fees to various winnings pools and to an administrative account. The game play module 136 also generates a list of actively participating players for each period that might result in awarding one or more winnings payouts. The random probability calculation modules 138(1) . . . 138(R) periodically calculate a probability function to determine whether there is to be a payout from a corresponding winnings pool for each period, and, if there is to be a payout for a particular period, select the player that wins the payout from the set of players actively playing during the period. The winnings payout module 140 receives notification of a payout from one or more of the random probability calculation modules 138(1) . . . 138(R), and, in turn, credits the accounts of winning players and notifies the players of the payout.

Illustratively, the storage 230 includes player account information 214, winnings pools information 216, and administrative account information 218. The player account information 214 includes data for each player of the online gaming system 130, including, without limitation, login credentials, an identifier of the client device 110 associated with the player, an identifier of an account from which to extract subscription fees and to which to transfer winnings payouts, a record of past winnings, subscription duration, and an identifier that determines whether to automatically renew subscriptions upon expiration. In one embodiment, player account information 214 may include identifiers for multiple client devices associated with a player. In such an embodiment, the player account information 214 may also include a maximum number of client devices that may simultaneously access the online gaming system 130. For example, a player could be limited to access the online gaming system 130 with one client device at a time. The winnings pools information 216 includes data for each winnings pool of the online gaming system 130, including, without limitation, the current balance of the winnings pool, the quantity of winnings payouts per subscription duration that have occurred, the amount or percentage of the winnings pool to be paid during the subscription duration, and the amount or range of each winnings payout. The administrative account information 218 includes data for the administrative account of the online gaming system 130, including, without limitation, the current balance of the account and the percentage or amount of each subscription fee to transfer to the administrative account.

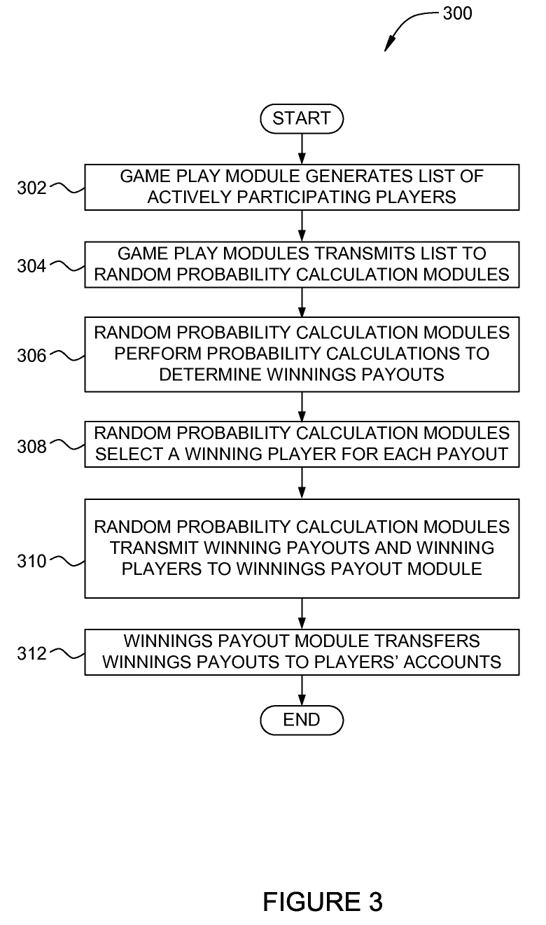

FIG. 3 sets forth a flow diagram of method steps for electronically paying out winnings for a particular probability calculation period, according to another embodiment of the present invention. Although the method steps are described in conjunction with the systems of FIGS. 1-2, persons of ordinary skill in the art will understand that any system configured to perform the method steps, in any order, is within the scope of the present disclosure.

As shown, a method 300 begins at step 302, where the game play module 136 generates a list of all players who are actively participating in game play on the online gaming system for the probability calculation period. At step 304, the game play module 136 transmits the list of all players who are actively participating in game play to each of the random probability calculation modules 138(1) . . . 138(R). At step 306, each of the random probability calculation modules 138(1) . . . 138(R) performs a random probability calculation to determine whether one or more winnings payouts is to be made from the corresponding winnings pool for the probability calculation period, the quantity of payouts to be made, and the amount of each payout. At step 308, each of the random probability calculation modules 138(1) . . . 138(R) selects players to receive each of the winnings payouts for the probability calculation period. At step 310, each of the random probability calculation modules 138(1) . . . 138(R) transmits winnings payout information to the winnings payout module 140, including the amount of each winnings payout and the identity of the player to receive the winnings payout. At step 312, the winnings payout module 140 credits the accounts of winning players. At step 314, the winnings payout module 140 notifies the players of the payout. The method 300 then terminates.

In sum, each player of an online gaming system is assessed a specific amount of money for a particular duration of time, such as a quantity of hours, a day, a week, or a month. In return, each player, via the player's client device, plays one or more online games associated with the online gaming system as often and as long as the player desires during the particular duration of time. The online gaming system then pools the money assessed from all players, and allots a particular percentage or amount of the pooled for the cost and profit of the providers and sponsors of the online gaming system. The online gaming system then allocates the remaining amount of the pooled money to one or more winnings pools, to be paid out to players. Portions of the winnings pools are paid out periodically and randomly to players who are actively playing a game associated with the online gaming system at the time a particular payout is made. Winnings payouts are based solely on the basis of the players who are actively playing a game, based on the client devices that are actively accessing the online gaming system. More particularly, winnings payouts are not based on skill or luck of the players. As a result, the chance to win increases with the amount of time a player actively plays a game, via the player's client device, on the online gaming system.

At least one advantage of the disclosed techniques is that large predictable winnings payouts are paid to players of online gaming systems, leading to predictable payouts and excitement among players. Another advantage of the disclosed techniques is that, because of the absence of per-game bets and the increase of winnings opportunities as game play time increases, the average amount of time spent playing increases relative to prior approach. These advantages lead to increased user participation. More particularly, players are encouraged to spend more time online with the online gaming system, regardless of the skill level of the individual players. Yet another advantage of the disclosed techniques is that the downside loss for any given player is fixed and limited to the periodic subscription fee. However, the potential winnings available for any given player increases as the quantity of subscribers increases. That is, the amount of money available for a player to win can increase over time, due to new subscribers, even though the player does not spend more money beyond the subscription fee.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., video processing and/or speech analysis applications) or related data available in the cloud.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A system, comprising:
a processor; and
a memory that includes a game play module and a first random probability calculation module;
wherein, when executed by the processor:
the game play module is configured to:
identify a first subset of client devices from a plurality of client devices configured to access an online gaming system, wherein each client device included in the first subset of client devices is actively accessing the online gaming system at a first point in time within a first time period, and
allocate a first portion of subscription fees collected from the plurality of client devices to a first winnings pool; and
the first random probability calculation module is associated with the first winnings pool and is configured to:
determine that a first jackpot is to be awarded at the first point in time within the first time period from the first winnings pool, and
select a first client device from the first subset of client devices identified by the game play module to receive the first jackpot.

2. The system of claim 1, further comprising a winnings payout module that, when executed by the processor, is configured to transfer at least a portion of the first winnings pool to an account associated with the first client device.

3. The system of claim 1, wherein, when executed by the processor, the winnings payout module is further configured to award one or more virtual items to a gaming account associated with the first client device.

4. The system of claim 1, wherein, when executed by the processor, the winnings payout module is further configured to post a notification associated with the first jackpot to a social media account associated with the first client device.

5. The system of claim 1, wherein, when executed by the processor, the game play module is further configured to:
identify a second subset of client devices from the plurality of client devices, wherein each client device included in the second subset of client devices is actively accessing the online gaming system at a second point in time within the first time period, and
allocate a second portion of subscription fees collected from the plurality of client devices to a second winnings pool;
and further comprising a second random probability calculation module associated with the second winnings pool that, when executed by the processor, is configured to:
determine that a second jackpot is to be awarded at the second point in time within the first time period from the second winnings pool, and
select a second client device from the second subset of client devices identified by the game play module to receive the second jackpot.

6. The system of claim 5, wherein the first subset of client devices and the second subset of client devices have at least one client device in common.

7. The system of claim 1, wherein, when executed by the processor, the game play module is further configured to allocate a second portion of subscription fees collected from the plurality of client devices to an account associated with a provider of the online gaming service.

8. The system of claim 1, wherein, when executed by the processor, the game play module is further configured to allocate a second portion of subscription fees collected from the plurality of client devices to a rebate pool, and further comprising a second random probability calculation module, that when executed by the processor, is configured to:
for each client device in the plurality of client devices:
determine a first point in time during the first time period when the client device is to receive a rebate payout,
determine that the client device is actively accessing the online gaming system,
determine that a current time is greater than or equal to the first point in time during the first time period, and
select the client device to receive the rebate payout from the rebate pool.

9. The system of claim 1, further comprising a network interface module that, when executed by the processor, is configured to communicate with the plurality of client devices.

10. The system of claim 1, further comprising a security validation module that, when executed by the processor, is configured to identify all client devices included in the first subset of client devices that are authorized to access the online gaming system for the first time period.

11. A computer-readable storage medium including instructions that, when executed by a processing unit, cause the processing unit to electronically pay out winnings associated with an online gaming system, by performing the steps of:
identifying a first subset of client devices from a plurality of client devices configured to access the online gaming system, wherein each client device included in the first subset of client devices is actively accessing the online gaming system at a first point in time within a first time period, and
allocating a first portion of subscription fees collected from the plurality of client devices to a first winnings pool; and
determining that a first jackpot is to be awarded at the first point in time within the first time period from the first winnings pool, and
selecting a first client device from the first subset of client devices identified by the game play module to receive the first jackpot.

12. The computer-readable storage medium of claim 11, wherein the instructions, when executed by the processing unit, further cause the processing unit to perform the step of transferring at least a portion of the first winnings pool to an account associated with the first client device.

13. The computer-readable storage medium of claim 11, wherein the instructions, when executed by the processing unit, further cause the processing unit to perform the step of awarding one or more virtual items to a gaming account associated with the first client device.

14. The computer-readable storage medium of claim 11, wherein the instructions, when executed by the processing unit, further cause the processing unit to perform the step of awarding additional game play time to a gaming account associated with the first client device.

15. The computer-readable storage medium of claim 11, wherein the instructions, when executed by the processing unit, further cause the processing unit to perform the step of posting a notification associated with the first jackpot to a social media account associated with the first client device.

16. The computer-readable storage medium of claim 11, wherein the instructions, when executed by the processing unit, further cause the processing unit to perform the steps of:
identifying a second subset of client devices from the plurality of client devices, wherein each client device included in the second subset of client devices is actively accessing the online gaming system at a second point in time within the first time period;
allocating a second portion of subscription fees collected from the plurality of client devices to a second winnings pool;
determining that a second jackpot is to be awarded at the second point in time within the first time period from the second winnings pool, and
selecting a second client device from the second subset of client devices identified by the game play module to receive the second jackpot.

17. The computer-readable storage medium of claim 11, wherein the instructions, when executed by the processing unit, further cause the processing unit to perform the step of allocating a second portion of subscription fees collected from the plurality of client devices to an account associated with a provider of the online gaming service.

18. The computer-readable storage medium of claim 11, wherein the instructions, when executed by the processing unit, further cause the processing unit to perform the steps of:
allocating a second portion of subscription fees collected from the plurality of client devices to a rebate pool; and
for each client device in the plurality of client devices:
determine a first point in time during the first time period when the client device is to receive a rebate payout,
determine that the client device is actively accessing the online gaming system,
determine that a current time is greater than or equal to the first point in time during the first time period, and
select the client device to receive the rebate payout from the rebate pool.

19. The computer-readable storage medium of claim 11, wherein the instructions, when executed by the processing unit, further cause the processing unit to perform the step of communicating with the plurality of client devices.

20. A method for paying out winnings associated with an online gaming system, the method comprising:
receiving requests from a plurality of users to access the online gaming system;
collecting a subscription fee from each user included in the plurality of users;
allowing each user included in the plurality of users to access the online gaming system for a period of time based on the subscription fee;
pooling a portion of the subscription fee collected from each user included in the plurality of users into a first winnings pool;
selecting a first time at which to award a jackpot, wherein the jackpot includes at least a portion of the first winnings pool;
identifying a subset of users included in the plurality of users, wherein each user in the subset of users is accessing the online gaming system at the first time;
selecting a first user from the subset of users; and
depositing the jackpot into an account associated with the first user.
